(19) United States
(12) Patent Application Publication
(10) Pub. No.: US 2025/0150180 A1
(43) Pub. Date: May 8, 2025

(54) CALCULATING INTERFERENCE SUPPRESSION WEIGHTS AND PROCESSING SIGNALS

(71) Applicant: Telefonaktiebolaget LM Ericsson (publ), Stockholm (SE)

(72) Inventors: Andres REIAL, Lomma (SE); Pål FRENGER, Linköping (SE); Joao VIEIRA, Hjärup (SE); Erik G. LARSSON, Linköping (SE); Omer HALILOGLU, Istanbul (TR)

(21) Appl. No.: 18/715,294

(22) PCT Filed: Dec. 3, 2021
(86) PCT No.: PCT/TR2021/051351

§ 371 Date: May 31, 2024

(51) Int. Cl. H04B 17/345; H04L 25/02

(52) U.S. Cl. CPC H04B 17/345; H04L 25/0202

(57) ABSTRACT

Methods and apparatus are provided. In an example aspect, a method in a first access point calculating interference suppression weights is provided. The method includes receiving, for each of at least one other access point, channel information for channels between the other access point and at least one User Equipment (UE), calculating, for each of the at least one other access point, the interference suppression weights based on the channel information received for the at least one other access point, wherein the interference suppression weights are for signals transmitted between the at least one other access point and the at least one UE, and sending, to each of the at least one other access point, the interference suppression weights for the other access point.

### TECHNICAL FIELD

Examples of the present disclosure relate to calculating interference suppression weights, such as for example uplink signal combining weights or downlink signal precoding weights, and processing signals.

### BACKGROUND

The project leading to this application has received funding from the European Union's Horizon 2020 research and innovation programme under grant agreement No 101013425.

Distributed multiple-input multiple-output (D-MIMO, also known as “cell-free massive MIMO”, Radio Stripes, or RadioWeaves) is a key technology candidate for the 3rd Generation Partnership Project (3GPP) 6th generation (6G) physical layer. The basic principle behind D-MIMO is to distribute service antennas geographically and have them operate phase-coherently together. In an example D-MIMO architecture, multiple antenna panels (also referred to as access points or APs) are interconnected and configured in such a way that more than one panel can cooperate in coherent decoding of data from a given UE, and more than one panel can cooperate in coherent transmission of data to a UE. Each antenna panel in turn may comprise multiple antenna elements that are configured to operate phase-coherently together. Example implementations may use time-division duplexing (TDD), relying on reciprocity of the propagation channel, whereby uplink pilots transmitted by the UEs are used to estimate both the uplink and downlink channel responses. This type of TDD operation may be referred to as reciprocity-based operation.

To make deployment of a large number of distributed MIMO access points simple and cost efficient, various solutions have been proposed, such as Radio Stripes and RadioWeaves. A common feature is to use a shared fronthaul together with a high degree of integration and miniaturization. An electronic circuit containing the digital signal processor (DSP), antenna panel, and external interfaces (for power supply and data) is called an antenna processing unit, or APU. In this document these will be referred to as access points (APs). An example of an APU or AP 100 is shown in FIG. 1. The AP 100 includes an antenna panel 102 that comprises four antenna elements 104. The AP 100 also includes four external interfaces 106. The external interfaces in the example AP 100 are located at the edges of the AP 100 such that they may communicate with one or more adjacent APs.

Multiple APs, such as the AP 100, may be connected directly or via one or more other APs to a processing node, also referred to herein as a central processing unit (CPU). In one example network 200, shown in FIG. 2, that uses an arrangement referred to as RadioWeaves, APs 202 may be connected to between one and four adjacent APs 202, and at least one of the APs 202 is connected to a CPU 204. Thus, each of the APs 202 may communicate with the CPU 204. In another example network 300, shown in FIG. 3, which uses an arrangement referred to as Radio Stripes, APs are arranged in multiple series arrangements, referred to as stripes 302, such that each stripe 302 includes multiple APs 304. Within a stripe 302, each AP 304 is connected to the two adjacent APs, with the exception of an AP 304 that is furthest from the CPU 306, which AP 304 is connected only to one adjacent AP 304. Another exception is the AP 304 closest to the CPU 306, which is connected to the CPU 306 and one adjacent AP 304. Thus each AP 304 in the stripes 302 can communicate with the CPU 306.

Processing, e.g. uplink reception, can be done in many ways in a D-MIMO system. An overview is presented in Emil Björnson and Luca Sanguinetti, “Making Cell-Free Massive MIMO Competitive With MMSE Processing and Centralized Implementation,” IEEE Transactions on Wireless Communications, vol. 19, no. 1, pp. 77-90, January 2020.

A common assumption in distributed MIMO is that the channel is reciprocal, and that uplink measurements can be used to estimate both the uplink (UL) and the downlink (DL) channels. In an example network, the number of UEs is denoted by K, the number of APs is denoted L, and the number of antenna elements in each AP is denoted N. For simplicity it is assumed that all APs have the same number of antenna elements, though in other examples the number of antennas may vary between APs. Each UE is assigned an uplink pilot sequence, which may not necessarily be unique, that can be used to estimate the channel between the UE and the AP(s) as well as statistical channel properties such as correlation matrices, average path gain and noise power. When the pilot sequence transmitted by the UE as a pilot signal has been received by one or more APs, the received signal can be used to perform channel estimation. When channel estimation has been performed, uplink data transmission can occur. A signal (e.g. a data signal) is received by one or more APs.

In one example, referred to as Level 4 processing, fully coherent combining of all signals is performed. This allows high performance, but it also has very high complexity as it requires a fully centralized network architecture, such as a central processing unit (CPU) that interconnects with every AP (directly or indirectly, e.g. as shown in FIG. 2 or 3). Signals from all antennas are forwarded to the CPU, which can implement a joint receiver for all users and AP signals. For minimum mean-square error (MMSE) combining, this nominally requires a large matrix inversion of size (NL×NL).

In Level 2 and Level 3 processing, each AP performs a first round of pre-processing using only the signals obtained from antenna elements in that AP, i.e. each AP performs local pre-processing operations. The so-obtained local estimates can then be forwarded to the CPU for a final combining. The difference between Level 2 and Level 3 is that Level 3 uses “optimal combining weights” while Level 2 uses “equal combining weights” when combining the local symbol estimates from each AP. “Equal combining weights” means that the symbol estimates from each AP are combined with unit weights or magnitudes (i.e. they are summed with no special weighting). “Optimal combining weights” refers to that the combining weights are calculated to minimize the error (e.g. in the MMSE sense), including both phase and magnitude optimization. APs with strong channels are given large weights and APs with weak channels are given small weights. The matrix inversion needed for calculation of local MMSE combining weights is of size (N×N).

One useful property of Level 2 and Level 3 combining is that the summation of local estimates can be performed sequentially as the signals are communicated from the APs towards the CPU. For example, if APs are configured in a daisy chain fashion such as for example shown in FIG. 3, signals from a first AP may be sent to the CPU via a second AP, which may then forward a combined version of the signals from itself and from the first AP to e.g. a third AP, and so on.

Finally, level 1 processing may be equivalent to a small cell deployment where each UE is assigned only the single best AP based on the average path gain, and each AP performs local processing involving only the UE(s) it is serving.

### SUMMARY

Examples of this disclosure may provide solutions for interference suppression weight computation that are scalable for arbitrarily large distributed deployments, but that also provide high performance.

One aspect of the present disclosure provides a method in a first access point (AP) of calculating interference suppression weights. The method comprises receiving, for each of at least one other access point, channel information (e.g. channel estimates) for channels between the other access point and at least one User Equipment (UE), and calculating, for each of the at least one other access point, the interference suppression weights based on the channel information received for the at least one other access point, wherein the interference suppression weights are for signals transmitted between the at least one other access point and the at least one UE. The method also comprises sending, to each of the at least one other access point, the interference suppression weights for the other access point.

Another aspect of the present disclosure provides a method in a second access point of processing signals. The method comprises sending channel estimates of channels between the second access point and the at least one UE to a first access point, receiving, from the first access point, interference suppression weights, and processing signals transmitted between the second access point and the at least one UE based on the interference suppression weights.

A further aspect of the present disclosure provides apparatus in a first access point (AP) of calculating interference suppression weights. The apparatus comprises a processor and a memory. The memory contains instructions executable by the processor such that the apparatus is operable to receive, for each of at least one other access point, channel information for channels between the other access point and at least one User Equipment (UE), calculate, for each of the at least one other access point, the interference suppression weights based on the channel information received for the at least one other access point, wherein the interference suppression weights are for signals transmitted between the at least one other access point and the at least one UE, and send, to each of the at least one other access point, the interference suppression weights for the other access point.

A still further aspect of the present disclosure provides apparatus in a first access point (AP) of processing signals. The apparatus comprises a processor and a memory. The memory contains instructions executable by the processor such that the apparatus is operable to send channel estimates of channels between the second access point and the at least one UE to a first access point, receive, from the first access point, interference suppression weights, and process signals transmitted between the second access point and the at least one UE based on the interference suppression weights.

An additional aspect of the present disclosure provides apparatus in a first access point (AP) of calculating interference suppression weights. The apparatus configured to receive, for each of at least one other access point, channel information for channels between the other access point and at least one User Equipment (UE), and calculate, for each of the at least one other access point, the interference suppression weights based on the channel information received for the at least one other access point, wherein the interference suppression weights are for signals transmitted between the at least one other access point and the at least one UE. The apparatus is also configured to send, to each of the at least one other access point, the interference suppression weights for the other access point.

Another aspect of the present disclosure provides apparatus in a first access point (AP) of processing signals. The apparatus is configured to send channel estimates of channels between the second access point and the at least one UE to a first access point, receive, from the first access point, interference suppression weights, and process signals transmitted between the second access point and the at least one UE based on the interference suppression weights.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of an antenna processing unit (APU) or access point (AP);

FIG. 2 shows an example of a network;

FIG. 3 shows another example of a network;

FIG. 4 is a flow chart of an example of a method in a first access point (AP) of calculating interference suppression weights;

FIG. 5 shows an example of a network according to an example of this disclosure;

FIG. 6 shows an example of a network according to another example of this disclosure;

FIG. 7 is a flow chart of an example of a method in a second access point of processing signals;

FIG. 8 is a schematic of an example of an apparatus in a first access point of calculating interference suppression weights;

FIG. 9 is a schematic of an example of an apparatus in a first access point of processing signals;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12 to 15 are flowcharts illustrating methods implemented in a communication system including a host computer, a base station (or access point) and a user equipment.

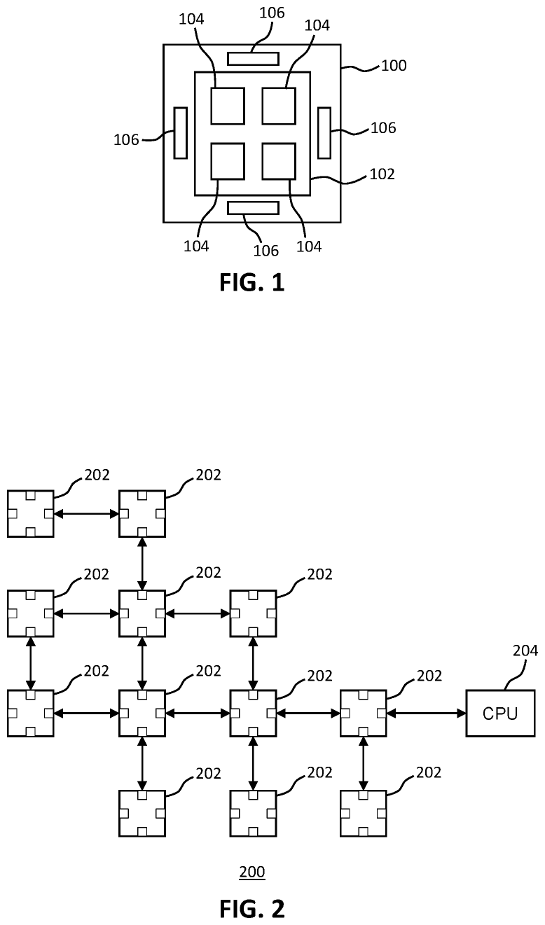

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Examples of this disclosure may provide systems, apparatus and methods that may be applied to a variety of distributed MIMO networks or system architectures. In a particular example, a distributed MIMO network including multiple APs may be connected to a processing unit, also referred to as a central processing unit (CPU), through a segmented fronthaul. Each fronthaul segment connects one AP with a neighboring AP or with the CPU. An AP can communicate with one or more another APs, or with a CPU through one or several (i.e. via one or more other APs) fronthaul segment hops. Multiple fronthaul segments can be active simultaneously. In some examples, each UE may be associated with a set of cooperating APs and an aggregation AP.

Fronthaul segments may in some examples simultaneously forward antenna signals (i.e. signals received at AP antennas) from the set of cooperating APs to the aggregation AP for each UE. Different aggregation APs may be used to process uplink signals for different UEs. Multiple aggregation APs can be active simultaneously.

A central processor (e.g. CPU) may in some examples control the allocation of hardware resources for signal processing and/or interference signal weight calculation. For example, the CPU may perform one or more of the following operations:
Determining the cooperating AP set for each UE
Allocation of fronthaul segment resources (including routing decisions) for local forwarding of antenna signals to aggregation APs
Allocation of processing capacity (i.e. selection of aggregation AP for each UE)
Forwarding and routing of decoded signals from aggregation APs to the CPU

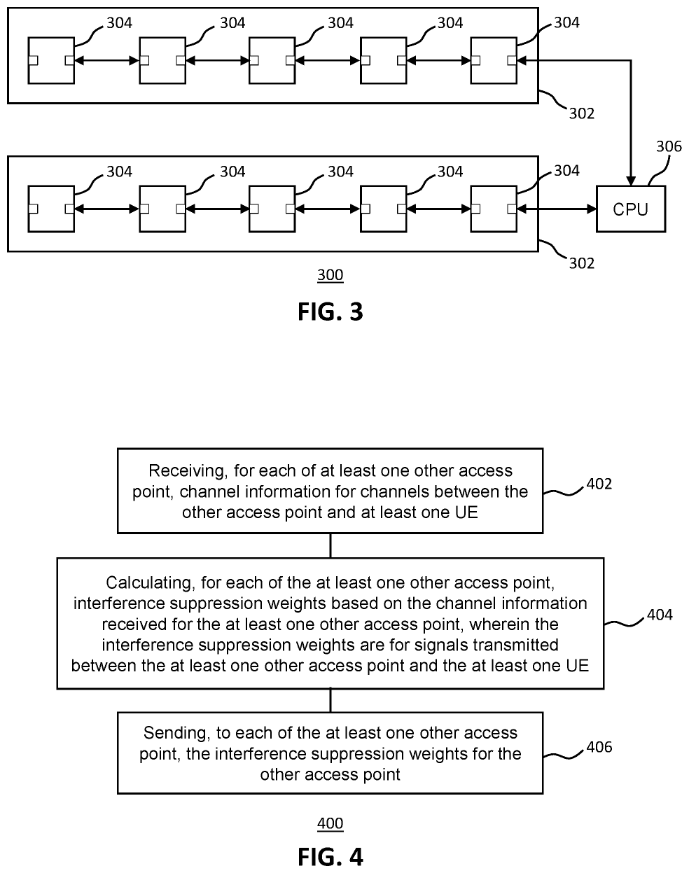

While simple matched filter-style combining of antenna outputs in UL processing in distributed MIMO deployments may in some examples provide basic functionality and macro-diversity benefits over centralized setups, the achievable performance is limited due to interference from co-scheduled users that dramatically limits the achievable signal to interference and noise ratio (SINR), throughput, and spectral efficiency. To introduce interference suppression using weights, MMSE-type weight solutions may be applied. However, current distributed architectures are not well suited for applying traditional MMSE solutions. For example, in level 4 processing, information from all APs for all UEs is made available to the CPU where advanced interference characterization over the entire UE population may be performed and joint weight optimization for all UEs is possible, which may maximize performance. In practice, however, the fronthaul capacity required for full channel information transfer from all APs to the CPU is often prohibitive, especially in architectures where not all APs are directly connected to the CPU but rely on sequential information routing, for example as shown in the architectures of FIGS. 2 and 3. In such cases, level 4 processing is generally not feasible. Also, determining interference suppression weights entails inverting large matrices which may be challenging from a computational complexity viewpoint. There may be also a latency challenge in terms of ensuring that suitable downlink precoder weights, which are computed from uplink channel measurements, are available at the APs within a time scale much smaller than the coherence time of the propagation channel.

In level 1 processing, in contrast, only UEs served by a certain AP are accounted for when that AP processes signals. This minimizes fronthaul traffic but leaves interference from other UEs uncontrolled, and the spatial degrees of freedom of local interference suppression are limited by the number of the antennas at the single AP which is expected to be low for massively distributed deployments.

In level 3 and level 2 processing, which may be considered as intermediate solutions between levels 1 and 4, local AP processing can apply limited spatial nulling on a per-AP basis, subject to same constraints as for level 1, and the CPU can further apply inter-AP weighting to achieve additional spatial selectivity. However, the inter-AP combining weights referred to in “Making Cell-Free Massive MIMO Competitive With MMSE Processing and Centralized Implementation,” referenced above, are long-term averaged and do not reflect short-term or instantaneous fading. Furthermore, the pre-combined values delivered to the CPU may not allow full flexibility for optimizing large-scale interference suppression, including for example handling potential interfering users not served by APs that performed the local AP processing. Similar concerns may also apply for precoding downlink (DL) transmissions, where zero forcing (ZF)-type solutions may be suboptimal if only applied on a per-AP basis, excluding protection to UEs that are not served by a given AP but nevertheless are receiving non-negligible energy from the AP.

The above networks and architectures may in some examples provide an efficient framework for applying advanced combining weights for UL combining of multiple AP data, but may not include procedures for DL weight handling or for generating the weights used in precoding (DL) or combining (UL). A solution is therefore desired for interference-aware DL precoding weight management, for example in distributed massive MIMO architectures with segmented fronthaul between the APs and the central processor, where effective interference suppression may be implemented without requiring centralized processing and excessive fronthaul traffic.

In some examples of this disclosure, interference suppression weights for DL precoding may be determined semi-locally, for example coordinated among multiple APs, but not calculated in a central processor such as a CPU. For example, interference suppression weights may be determined for a subset of APs in a distributed MIMO layout. Weight computation for the subset of APs, which are referred to herein as a coordinated AP set (CAPS), may be performed in some example in an associated AP that is referred to herein as a weight coordination AP (WCAP).

In examples of this disclosure, interference suppression weights may for example refer to downlink (DL) precoding and/or uplink (UL) combining weights that optimize other signal transmission or reception aspects besides desired signal collection at the receiver, e.g. interference mitigation to other users due to said transmissions, or interference mitigation from other users in the course of said reception. Examples of interference suppression weights may include linear weight solutions such as zero-forcing (ZF) and minimum mean square error (MMSE) techniques.

In some examples, in a configuration step, which may be performed infrequently, the central processor determines the CAPS for one or more UEs and its associated WCAP. In some cases, this may be determined ahead of time in a network deployment, or the WCAP may be selected from a particular subset of APs in the network. For example, the WCAP may be selected from APs with larger computational capacity for WCAP functions than other APs.

In another configuration step, in some examples, the central processor may determine which UEs' signals should be considered in the weight computation, such as for example UE(s) whose transmitted signals exceed an absolute or relative power level threshold at one or more APs in the CAPS. The set of such UEs may in some examples include at least the set of UEs served by any AP in the CAPS but may also include additional UEs. In some examples, in the configuration step, the following steps may be repetitively performed and may also be repeated at intervals that in some examples do not exceed the channel coherence time:
1. Channel information for associated UEs (e.g. those served by the CAPS) is provided from APs in the CAPS to the WCAP.
2. Based on the channel information, the WCAP computes an interference suppression weight set for all APs and all users served in the CAPS, e.g. a weight per antenna element per AP per UE whose signals are to be combined, but additional UEs' channel info may be used for interference modeling.
3. The WCAP distributes the weight values to the APs in the CAPS and the APs use them for antenna processing (e.g. for UL and/or DL signals).
4. Steps 1-3 may be repeated when updated channel estimates are available.

Separate weight sets may be designed for UL and DL in some examples, or a robust weight set may be determined that may be used for both.

Examples of this disclosure may provide solutions for interference suppression weight computation that are scalable for arbitrarily large distributed deployments. The CAPS size and fronthaul (FH) overhead can in some examples be kept constant, for example where the number of CAPS sets in the network is proportional to the total number of APs served by a central processor. Examples of this disclosure may provide significantly improved performance at a limited complexity increase compared to single AP decoding (Level 1) or sequential AP aggregation (Level 2 or Level 3) with local weights. Examples of this disclosure may approach the performance of optimal centralized processing (Level 4) as the size of the CAPS expands. Applying interference suppression according examples of this disclosure may increase user throughput and/or system capacity for a distributed MIMO deployment.

FIG. 4 is a flow chart of an example of a method 400 in a first access point (AP) of calculating interference suppression weights, for example for uplink (UL) signal combining and/or downlink (DL) signal precoding. The method comprises, in step 402, receiving, for each of at least one other access point, channel information for channels between the other access point and at least one User Equipment (UE). The at least one other access point may in some examples be a group of coordinating access points, such as a CAPS as referred to above. In such examples, therefore, the first AP may comprise the weight computation AP (WCAP) referred to above that is associated with the CAPS. In some examples, a UE may be associated with multiple CAPS. Additionally or alternatively, for example, an AP may be associated with multiple CAPS (and serve multiple groups of UEs each with an associated CAPS for example). Additionally or alternatively, for example, the first access point (e.g. a WCAP) may calculate weights for multiple AP groups, that is, for example, the first AP may be the WCAP for multiple CAPS.

Step 404 of the method 400 comprises calculating, for each of the at least one other access point, the interference suppression weights based on the channel information received for the at least one other access point, wherein the interference suppression weights are for signals transmitted between the at least one other access point and the at least one UE. Step 406 comprises sending, to each of the at least one other access point, the interference suppression weights for the other access point. The at least one other AP(s) may then use the interference suppression weights, which may for example vary between access points, to perform DL signal precoding and/or UL signal combining in a manner that may suppress interference towards one or more UEs, and/or may suppress interference received from one or more UEs (which may for example include UE(s) that are not served by the at least one other AP(s)). In some examples, the first AP (e.g. WCAP) may or may not be a member of the group of APs (e.g. the CAPS) that is serving the at least one UE.

As a result, for example, interference suppression weights may be calculated in a decentralized manner by a node other than a CPU or central processor, for example by an access point. Furthermore, for example, performance may be improved compared to other decentralized solutions (e.g. level 1 processing referred to above) as the first AP calculating the weights may use channel information such as channel estimates from multiple APs to determine the interference suppression weights.

In some examples, the channel information for channels between the other access point and the at least one UE for each of the at least one other access point comprises channel information between each antenna of the other access point and each of the at least one UE. Thus, for example, the interference suppression weights for signals transmitted between each of the at least one other access point and the at least one UE comprise interference suppression weights for signals transmitted between each antenna of the other access point and each of the at least one UE.

In some examples, as indicated above, the first AP may also be an AP that is serving the at least one UE (e.g. is in the group of APs comprising the CAPS for the at least one UE). Thus, for example, the method 400 may comprise determining channel information for channels between the first access point and the at least one UE. As a result, for example, calculating the interference suppression weights based on the channel information received for the at least one other access point comprises calculating the interference suppression weights based further on the channel information for channels between the first access point and the at least one UE. This may for example include calculating, for the first access point, interference suppression weights for signals transmitted between the first access point and the at least one UE. The method 400 may thus further comprise in some examples transmitting signals to the at least one UE based on (e.g. precoded using) the interference suppression weights for the first access point, for example if the weights are DL signal precoding weights.

In some examples, the method 400 may comprise receiving, for each of at least one of the at least one other access point, channel information for channels between the other access point and at least one additional UE, wherein the at least one additional UE is not served by the group of access points serving the at least one UE. For example, the at least one additional UE may be transmitting signals that cause interference to the at least one AP, and/or the at least one AP may be transmitting signals that cause interference to the at least one additional UE. Thus, for example, calculating, for each of the at least one of the at least one other access point, the interference suppression weights based on the channel information received for the at least one other access point in step 404 may comprise calculating the interference suppression weights based further on channel information for channels between the other access point, and wherein the interference suppression weights cause the at least one of the at least one other access point to suppress interference towards or from the at least one additional UE.

The interference suppression weights may in some examples cause at least one of the at least one other access point to not transmit to at least one of the at least one UE. For example, this may be performed in view of power requirements of an AP, where an AP has a maximum transmission power that effectively limits the number of UEs to which it may simultaneously transmit signals. Thus, for example, the method 400 may include selecting the at least one of the at least one other access point and/or the at least one of at least one of the at least one UE based on a respective maximum transmit power of the at least one of the at least one other access point.

The method 500 may in some examples comprise receiving, from at least one of the at least one access point, an indication of a scaling parameter for the interference suppression weights for the at least one of the at least one AP, and updating the interference suppression weights for each of the at least one other access point based on the scaling parameter. This may be for example because an AP would otherwise exceed its maximum transmit power using the weights determined in step 404 (including in some examples when the AP would also transmit to additional UEs associated with other CAPSs, where the AP belongs to multiple CAPSs). As a result, for example, the entire set of weights may be adjusted or scaled so that the AP's maximum transmit power is not exceeded. The method 500 may thus also comprise sending, to each of the at least one other access point, the updated interference suppression weights for the other access point. The at least one other access point(s) may then use the updated weights for their transmissions to the UEs (or for combining signals from the UEs).

In some examples, the interference suppression weights may comprise, for at least one of the at least one access point, first interference suppression weights for signals transmitted between the at least one of the at least one other access point and a first subset of the at least one UE, and second interference suppression weights for signals transmitted between the at least one of the at least one other access point and a second subset of the at least one UE. The first and second subsets may be for example overlapping subsets, where for example the first subset of UEs is associated with a first CAPS of which the at least one of the at least one access point is a member, and the second subset of UEs is associated with a second CAPS of which the at least one of the at least one access point is also a member. That is, for example, one or more APs may belong to multiple CAPSs.

In some examples, each other AP may be connected to the first AP over a direct or indirect fronthaul (FH) link. Thus, for example, the method 400 may comprise receiving, for each of at least one other access point, the channel information for the channels between the other access point and the at least one UE comprises receiving the channel information over a respective fronthaul link between the other access point and the first access point. In addition, for example, the method 400 may comprise sending, to each of the at least one other access point, the interference suppression weights for the other access point comprises sending the interference suppression weights over the respective fronthaul link between the other access point and the first access point. In some examples, the fronthaul links may be direct links, in which case, each other AP is connected directly to the first AP via a respective FH link.

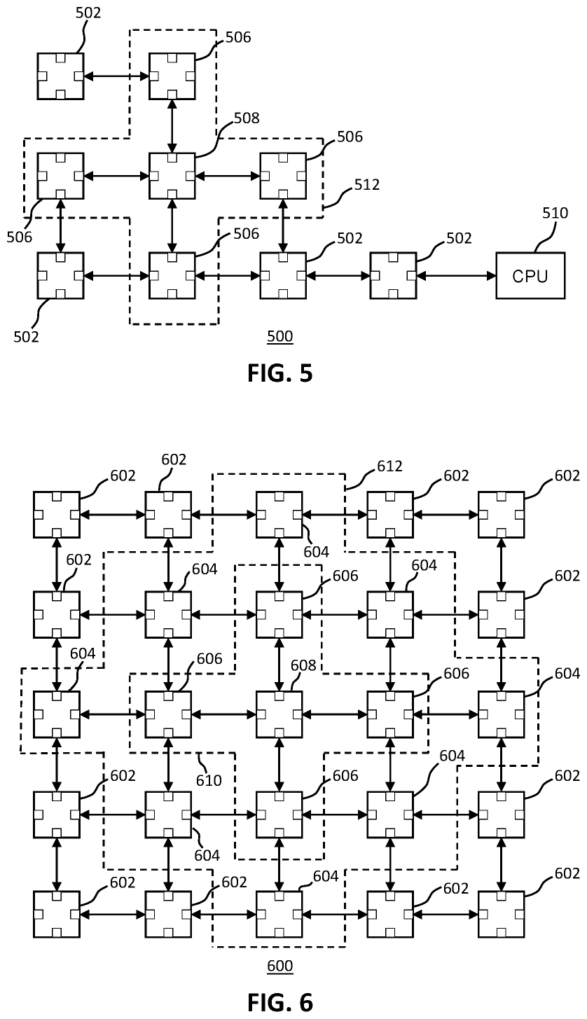

FIG. 5 shows an example of a network 500 that includes access points 502, 504, 506, 508 that can communicate with a central processor (CPU) 510. The arrangement of the APs is similar in this example to the Radio Weaves arrangement shown in FIG. 2, although other arrangements of APs are possible. Five of the APs 506, 508 are grouped into a group of APs 512 (e.g. a CAPS) that may serve one or more UEs. A first AP 508 may be designated for example as the WCAP for the group 512 and is connected to each of the other APs 506 in the group by respective direct fronthaul links. The APs in the group 512 may communicate with the CPU 510 via other APs, including APs not in the group 512, although in other examples or groups at least one AP may be directly connected to the CPU 510.

In some other examples, however, one or more of the other APs is connected indirectly to the first AP (i.e. via at least one other AP). Thus, for example, the method 400 may comprise receiving, for each of a first subset of the at least one other access point, the channel information for the channels between the other access point and the at least one UE over a respective fronthaul link (e.g. a direct link) between the other access point and the first access point. The method 400 may also for example comprise receiving, for each of a second subset of the at least one other access point, the channel information for the channels between the other access point and the at least one UE from the other access point via the respective fronthaul link between the first access point and one of the first subset, wherein the first subset is different to the second subset.

Consequently, the method 400 may therefore in some examples comprise sending, to each of the first subset of the at least one other access point, the interference suppression weights for the other access point over the respective fronthaul link between the other access point and the first access point, and sending, to each of the second subset of the at least one other access point, the interference suppression weights for the other access point over the respective fronthaul link between the first access point and one of the first subset.

FIG. 6 shows another example of a network 600 that includes access points that are not directly connected to the first AP. The network 600 includes access points 602, 604, 606 and 608. A first subset 610 of APs includes APs 606 that are connected directly to a first AP 608 (e.g. a WCAP) via respective fronthaul links. A second subset 612 of APs 604 are connected to the first AP 608 via one of the APs 606 of the first subset 610. The APs 602, 604, 606 and 608 may also communicate with a central processor (not shown). A group of APs serving one or more UEs may include the first subset 610 and the second subset 612, and may in some examples also include the first AP 608.

In some examples, the size of a group of APs serving one or more UE(s) may be limited by the capacity for transporting channel information and weights over the fronthaul segments (links). For example, fronthaul overhead due to transporting this information may be minimized by selecting only a group of APs that are connected directly to a first AP or WCAP, as shown for example in FIG. 5. Only FH segments directly connected to the first AP will then experience an overhead due to participation in the group. This approach for example provides MN degrees of freedom for steering signal energy and interference nulls, where M is the number of APs in the group (which may also include the first AP in some examples).

The CAPS size, and interference control ability, may in some examples be extended by allowing APs that are not directly connected to the first AP. For example, APs up to a depth D from the first AP may be in the group of APs, where the depth D is the maximum distance of an AP from the first AP (directly connected APs have a depth D=1, APs connected via one other AP have depth D=2 and so on). For depth D, the CAPS size becomes M=O((D+1)²) or O((D+1)³) depending on the AP connection geometry (e.g. 2D or 3D). This may in some examples lead to increased FH overhead (for transporting additional channel and weight information) and increased weight computation complexity at the WCAP compared to scenarios where the CAPS is limited to a smaller depth. Thus, the first AP or WCAP may in some examples be implemented as a specialized AP type with higher processing capability than other APs. The available spatial degrees of freedom will be significantly increased and allow efficient interference suppression, placing more nulls to protect more UEs. As shown in FIG. 6, the APs 606 in the first subset 610 have depth D=1 and the APs 604 in the second subset 612 have depth D=2 (which means that the maximum depth of the group of APs or CAPS is 2).

In uniform layouts, such as for example 2D layouts an example of which is shown in FIG. 6, it may be possible to form non-overlapping equal-sized groups of APs (e.g. CAPSs) with uniform depth. This is not true in irregular layouts or near the edges of the AP grid, in which the layout may be complemented with smaller or partially overlapping groups of the selected depth.

In some example networks, a group of APs (e.g. a CAPS) serving one or more UEs may be defined to include an arbitrary number of APs including APs that are at different depths from the first AP, such as for example shown in FIGS. 5 and 6. This way, AP groups can in some examples have shapes that simplifies CAPS planning over larger coverage areas. For example, referring to the arrangement of APs shown in FIGS. 5 and 6, instead of the generally cross-shaped AP groups or CAPSs, a CAPS can have a rectangular shape to simply “tiling” of APs into groups. More generally, a network according to examples of this disclosure may include any number of one or more AP groups or CAPSs. In some examples, two or more groups may overlap, such that an AP may belong to two, three or more groups. Each AP group may serve a particular group of one or more UEs, though in some examples a UE may belong to multiple groups (and hence be served by multiple AP groups or CAPSs). Using overlapping CAPS approach may in some examples allow a sufficient-sized CAPS while enforcing a depth constraint, or may in some examples allow APs to be included in a group where otherwise these APs may remain between groups.

In some examples, the network may also include fronthaul segments that also interconnect APs that are not neighbors of each other (i.e. non-neighbor fronthaul segments). More specifically, for example, in addition to the architectures considered above an AP has fronthaul segments to one or more of its neighbor APs, there may also exist fronthaul segments interconnecting pairs of APs which are otherwise distanced by N neighbor fronthaul segments. For a given number of such non-neighbor fronthaul segments which are available to be distributed in the network, in some examples, these segments or links may be deployed such that the maximum number of fronthaul segments between any pair of APs is minimized. For example, if only one non-neighbor fronthaul segment is deployed in a rectangular 7-by-7 AP array, where all APs have fronthaul segments to its neighbors, then such non-neighbor fronthaul segment may interconnect the AP in the 4th row and 2nd column to the AP in the 4th row and 5th column. This ensures that the maximum number of fronthaul segments between any pair of APs is 9, instead of 12, i.e. the Mahalanobis distance between opposite corners of a 7-by-7 grid. Thus, in some examples the benefits of such additional non-neighbor interconnect(s) are that they add additional fronthaul segments which can be used for data transfer between APs (perhaps in parallel with other FH segments), and also that signals from distant APs may reach the first AP faster than compared to forwarding these signals to the first AP via neighbor fronthaul segments only.

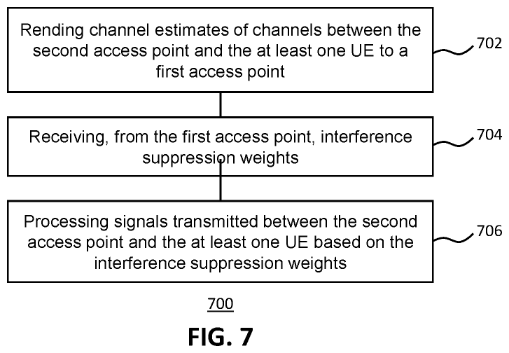

FIG. 7 is a flow chart of an example of a method 700 in a second access point of processing signals. The second access point may be for example an “other” AP referred to above with reference to FIG. 4, and may in some examples be an AP in a group or CAPS as referred to above and shown in FIGS. 5 and 6. The second access point may for example be in a group of access points (e.g. a CAPS) serving the at least one UE. The method 700 comprises, in step 702, sending channel estimates of channels between the second access point and the at least one UE to a first access point, such as the first AP or WCAP referred to above, and/or the first AP 508 or 608 shown in FIG. 5 or 6. Step 704 of the method 700 comprises receiving, from the first access point, interference suppression weights, such as for example downlink signal precoding weights and/or uplink signal combining weights. Step 706 comprises processing signals transmitted between the second access point and the at least one UE based on the interference suppression weights. This may comprise for example transmitting DL signals based on (e.g. precoded using) the weights, and/or processing received UL signals using the weights. The interference suppression weights comprise weights for each antenna of a plurality of antennas of the second access point and for each UE of the at least one UE. In other words, the weights may be per-antenna weights for the second AP.

In some examples, the method 700 may comprise receiving, from each of at least one other access point, channel estimates of channels between the second access point and the at least one UE, and forwarding the channel estimates from the at least one other access point to the first access point. This may be the case for example where the second AP is between the other AP(s) and the first AP, and information from the other AP(s) is sent to the first AP via the second AP. Similarly, in some examples, the method 700 may also comprise receiving, from the first access point, respective other interference suppression weights for each of the at least one other access point, and forwarding, to each of the at least one other access point, the respective other interference suppression weights. It may be the case however in some examples that the channel information may be sent from an AP to the first AP using a different path than the interference suppression weights returned by the first AP.

To identify the first AP, information identifying the first access point (e.g. by using any locally or globally unique address or indicator, or a MAC address, an Internet Protocol, IP, address, etc) may be received from a processing node such as a CPU (e.g. the CPU 510 shown in FIG. 5).

As suggested above, the interference suppression weights may in some examples comprise weights for each antenna of a plurality of antennas of the second access point and for each UE of the at least one UE. The interference suppression weights may for example cause the second access point to suppress interference towards at least one additional UE, wherein the at least one additional UE is not served by the group of access points or CAPS serving the at least one UE.

In some examples, the interference suppression weights may cause the second access point to not transmit to at least one of the at least one UE.

Examples of assigning UE(s) to a group of APs (e.g. a CAPS) to serve the UE(s) is described as follows. The UE(s) may be assigned to a CAPS by a central processor such as a CPU such that the UEs meet or exceed an absolute or relative power level threshold at any AP in the CAPS. The relative power level may be related to the highest UE power received at the AP. Alternatively, the power level may be the total power received in a CAPS from a UE. The power metrics are preferably averaged over multiple fading cycles. Alternatively, for example, the relative power level may be related to the power level the UE receives on downlink, and which may be reported by the UE on a control channel.

In some examples, the set of UEs served by a group of APs or CAPS includes at least all UEs served by the CAPS APs, i.e. the union of the users served by at least one AP in the group, which may be referred to as UEs associated with the CAPS. It may also include additional UEs, e.g. not served by APs but received with power exceeding the above threshold, referred to as UEs affecting the CAPS.

In other examples, if the total number of antennas in the CAPS is lower than the size of the union of the UEs, the number of spatial degrees of freedom may be a limiting factor. The weight solution may then provide weights for min (K1, MN) UEs, e.g. in the zero forcing (ZF) sense, where K1 is the size of the union of the users served by at least one AP in the group and MN is the total number of antennas over all APs in the CAPS. Any remaining K1-MN UEs may be treated in the MF (matched filtering) sense.

There may be examples where non-overlapping AP groups (e.g. CAPSs with no AP in common) are associated with (e.g. serve) different UEs. In some examples, each group of APs may only serve its associated UEs, e.g. each CAPS only measures the channel of its intended UE and computes respective interference suppression weights. In such examples, it may be that beamforming techniques for multi-user interference suppression via coherent processing cannot be employed. Therefore, in some examples, it may be ensured that the minimum requirements for multi-user interference suppression via coherent processing are met during the assignment of UEs to CAPSs. For example, in the case of serving two UEs, then at least one AP may be assigned to the two UEs (e.g. one AP is common to two CAPSs) where the AP has a number of antennas of at least two, i.e. N≥2. In the example case of serving three UEs, then it may be ensured that either at least one AP is assigned to the three UEs where the AP has a number of antennas of at least 3, or that at least one AP is assigned to first and second UEs, and another AP is assigned to second and third UEs, where each of these APs has at least two antennas. This way, one of the APs may employ interference suppression schemes for communications with the first and second UEs, and the other AP may apply interference suppression for communications with the second and third UEs. In some examples these two APs may each belong to a group that includes other APs serving one or more of the UEs.

Examples of channel estimation at the UEs are described as follows. An AP may perform channel estimation with respect to one or more UEs according to known techniques (for example, based on UL demodulation reference signals (DMRS) and/or sounding reference signals (SRS) in 3GPP New Radio (NR) systems). The set of UEs to estimate channels for at the AP may be the UEs associated with the CAPS and may also in some examples include UEs affecting or affected by the group of APs (e.g. the additional UEs referred to above). The set of UEs for channel estimation may in some examples be identified to the AP by the central processor, along with information necessary for estimation such as for example UE identifier (ID), DMRS or SRS scrambling, and any other suitable information.

The number of UEs for which an AP can perform channel estimation may be limited in some examples by its available processing resources. In some examples, the central processor configures the AP to perform channel estimation for a number of UEs not exceeding the processing capability of the AP, which the AP may in some examples signal to the central processor, for example at the time of network setup. In other examples, the CPU may identify the UEs for channel estimation as a list in a decreasing order of importance, and the AP will perform channel estimation for UEs starting from the top of the list according to its processing capability.

The central processor may in some examples apply location-aware channel estimation, for example by using the geographical location of the UE, where channel estimate and location data gathered from other UEs previously associated to the group of APs may be utilized (for example using machine learning techniques) for further channel estimation for UEs newly associated with the group of APs. The location information can be gathered directly from the UEs by an AP or by the network using positioning algorithms such as triangularization.

In other examples, assuming the UE location is known, the group of APs may use an average channel estimate over all APs in the CAPS, which mainly depends on the distance dependent path loss and high probability of Line-of-sight (LOS), which decreases the frequency of transfer of channel estimates. For instance, average channel estimates may only change when UEs move a long distance (e.g. meters), and the UEs can in some examples be considered “stationary” during short time intervals such as 1-100 ms. The cost of distributing this information to all APs is low, since it needs to be updated very seldom. As a result, it can in some examples be assumed that all APs know the average channel estimates. In contrast, for example, fast fading changes if the UE moves by a distance of around half a wavelength of the transmitted signal. This information may in some examples need to be updated frequently, and it cannot be assumed that APs know the fast fading that other APs observe.

The periodicity of channel estimation may in some examples be determined by the time-variability of the channel, such that channels that vary more slowly are estimated less frequently. Information on the channel time-variability may be obtained by computing statistics from past channel estimates. The channel estimates may also be filtered in the time and frequency domain, using for example a Kalman filter or an approximation thereof.

Channel estimates for UEs for which channel estimation was not performed may be set to zero in subsequent processing in some examples.

Upon performing channel estimation, the channel information for each UE is provided to the first AP along a previously configured route in some examples. The route (e.g. sequence and time instances of use of fronthaul segments) may in some examples determined by the CPU and signaled to each AP. The channel information may for example be provided as a single block during a single time instance per segment or sequentially, per UE or UE subset, over multiple time instances per segment.

Upon receiving channel information for UE(s) from APs in a group of APs, the first AP may in some examples calculate interference suppression weights for UEs associated with the group of APs. In some examples, one weight value per antenna element per AP in the group per UE associated with the group is computed. In some examples, additional channel information for UEs affecting or affected by the group (but not associated with or served by served by the group) may be used for interference modeling.

In some examples, the frequency domain may be partitioned into coherence blocks, during which the channel is considered as a substantially static linear system. One weight value per antenna element per AP in the group of APs per UE associated with the group may then be computed for each coherence block. The frequency width of the coherence block (i.e. the coherence bandwidth) may be determined for example on a per-UE basis by the first AP or the central processor based on statistics of past channel estimates. For example, the coherence bandwidth can be estimated by determining the channel frequency response at several different instances in time and for several or all antennas, and then estimating the length of a frequency segment over which this channel frequency response remains substantially constant. In some examples, a windowed short-term Fourier transform of the channel estimates may also be determined in order to determine the channel coherence properties.

Examples of this disclosure may be used for a wide range of linear interference-mitigation weight usage methods, including any suitable method for transmitter precoding such as for example zero forcing (ZF) or signal to leakage plus noise ratio (SLNR), and/or any suitable method at the receiver such as for example interference rejection combining (IRC) or minimum mean square error (MMSE). These methods may use channel information for a selected UE and interference modeling information for additional UEs to determine the weights for the selected UE. The channel information may in some examples include both the actual channel estimates and information about their accuracy (for example, the error covariance). The set of UEs whose channel information is used for interference modelling may in some examples be larger than the set of UEs targeted by the group of APs for data transmission.

To illustrate an example of weight computation, such as that performed in step 404 of the method 400 described above, a R-ZF precoding weight computation example is provided. Let the group of APs include M APs, each equipped with N antennas, serving K/single-antenna terminals, which are the UEs associated with the group of APs. (Multi-antenna UEs may be handled using extension methods.) For UE k, the weight solution may be expressed as:

$${w}_{k} = {{h}_{k}^{H} ( {\sum }_{i = 1}^{K 2} E [ {h}_{i} {h}_{i}^{H} ] + R )}^{- 1}$$

where the hᵢ is an MN×1 channel estimate vector for UE i. R is an implementation-specific regularization term which may be diagonal, or have a positive semi-definite structure, e.g. capturing the structure of correlated, AP-specific channel estimation errors. This may be estimated locally at an AP in some examples. The first AP may compute weights for the associated UEs k=1 . . . . K1 but the summation in interference modeling may in some examples be performed over more UEs (K2>=K1), including UEs that affect or are affected by but are not served by APs in the group of APs (e.g. CAPS). k=K1+1 . . . . K2 are UEs affected by, but not served by, the group of APs. The expectation (averaging) operation in weight computation operation may be omitted in some examples depending on implementation, for example based on whether instantaneous interference modeling or modeling noise reduction is prioritized.

In some examples, the channel estimates for affecting/affected but not associated UEs, k=K1+1 . . . . K2, are not provided coherently. Since they are only used as part of the sum and after applying an expectation, the long-term averaged outer product info may be generated for those users, instead of obtaining complex coefficients that follow the fast fading. A formulation may be used as follows:

$${w}_{k} = {{h}_{k}^{H} ( {\sum }_{i = 1}^{K 1} E [ {h}_{i} {h}_{i}^{H} ] + C + R )}^{- 1}$$

where C=Σ_{i=K1+1}^{K2} E[hᵢhᵢ^{H}]=Σ_{i=K1+1}^{K2} Cᵢ and the second-order info Cᵢ may be provided and/or processed at a lower rate at the WCAP and via the FH segments. In some examples of practical implementations, weight solutions for multiple UEs may be computed jointly in the first AP. Using ZF/MMSE-type weight solutions in some examples, signals for all K1 associated UEs may be transmitted from all APs in the group of APs in order to correctly apply interference suppression based on the computed weights. This may mean in some examples that an AP in the group may transmit signals to additional UEs as well as the served UEs.

In some examples, R may also include the covariance of interference corresponding to other directions than the K2 UEs, for example, directions in which it is intended to avoid spreading interference.

In some examples, to reduce the fronthaul overhead used due to serving additional users from some APs, signals only for UEs with non-zero weights at a given AP need to be transmitted to obtain the intended interference suppression gain. Other weights can in some examples be assumed to be zero. For example, to reduce data routing over the fronthaul, weight values for a UE in one or more APs in the group of APs may be forced to zero and the remaining weight values determined numerically and iteratively, jointly for multiple users. The numerical optimization may be based for example on maximizing a performance metric for the associated UEs, e.g. estimated SINR. Any suitable numerical optimization method may be used, including gradient-based, genetic algorithms, annealing, etc. In some examples, the above closed-form solutions for users k=k . . . K1 may be used as a starting point, and weight values in the closed-form solution whose magnitude does not exceed a threshold are fixed at zero. In other examples, weight values corresponding to APs where a given UE is not served may be fixed at zero, and non-zero weights are allowed for APs and UEs that are served by the group of APs.

In other examples, if any AP is included in multiple AP groups, then the weights for different UEs for the particular AP may be scaled or normalized in order to meet any constraints, such as for example maximum transmission power constraints. To configure appropriate scaling, for example, an AP may send feedback to the first AP about the scaling it requires or the maximum transmission power capability of the AP. The first AP may then adjust the weights using the feedback received from the AP, and then redistribute the updated weights to all APs in the group.

Thus, some example methods of this disclosure may include the following steps. APs may calculate the scale to meet the constraint and provide feedback to the first AP. Next, the first AP resets the weights based on the feedback and redistributes the updated weights to all APs in the group. In some examples, the iteration process may end when there is a below threshold change in the last iteration, or where a maximum number of iterations is reached.

In some examples, computed interference suppression weights whose magnitudes are less than a pre-determined threshold may be set to zero and not transmitted to the APs, thereby saving fronthaul capacity. Weights may also be adaptively quantized, for example, by applying a pre-determined nonlinear mapping to the weight after its quantization, then quantizing uniformly, and then (before application of the weight) applying the inverse nonlinear mapping.

In some examples, computed weights for each AP in the group of APs are transported from the first AP to the respective APs over fronthaul segments that may be previously defined. Each AP in some examples receives N weights, one per AP antenna, for each UE that it serves and/or for which it has non-zero weight coefficients. In some examples, the first AP may determine that some antenna weights will be zero for all UEs for a particular AP (for example, turning the corresponding transmitters or antennas off), and in that case the AP will receive fewer than N coefficients per UE. In some examples, the routing (e.g. the sequence and time instances of use of fronthaul segments) for transport of the weights to the APs in the group may be determined and signaled beforehand to the first AP by the central processor (e.g. CPU).

In some example scenarios, an AP may be a member of multiple AP groups. This AP may then receive multiple weight values for a particular UE (or multiple UEs). For downlink transmission, in some examples, the multiple weight sets for a UE may be handled in a superimposed manner. The different precoding weights for the different AP groups (or CAPSs) for a given UE may be for example summed and applied to the UE symbol in a single transmission operation. In some examples, the power at each participating node contributed towards each interference suppression solution (e.g. ZF) should preferably result in proper interference nulling, and to ensure that a downlink power constraint per AP is satisfied.

In some examples, the maximum allowed number of group memberships per AP (i.e. the maximum number of groups an AP can belong to) may be defined, which is referred to as J, and the transmit power of each transmission by an AP group may be scaled by 1/J to meet the maximum power constraint per AP. The transmission power from an AP that is a member of the maximum number of groups thus will not exceed the transmission power capability of the AP. In some examples, the groups may be configured so as to include every AP (or a majority of APs) in the network in an equal number J of groups, in which case the full transmission power capability of all (or the majority) of APs may be utilized when the 1/J scaling is applied.

In other examples, each AP may be included in only one group (although there may still be multiple groups). However, if an AP is included B groups, where B is at least 2, the AP may scale down its signal transmissions for each group by the same factor 1/B. Alternatively, in some examples, the power allocation (or the scaling) between the B groups may be uneven, e.g. proportional to the weight vector norm or magnitude of individual weights corresponding to the different AP groups. However, in some examples of this disclosure, constrained weight computation approaches can also include AP-specific power constraints in the iterative weight optimization process, in which case any AP with multiple group memberships can be handled individually and no overall power scaling at the AP may be used.

In some examples, the interference suppression weights may not be simultaneously optimized for both DL precoding and UL combining. The high-level structure of the DL and UL weight solutions may be similar in some examples, consisting of a channel estimate vector and an inverse of an impairment covariance matrix, where the covariance matrix may be modeled as a sum of rank-1 outer products of interfering UEs' channels and a regularizing term. However, the physical meaning and structure of the regularizing term may differ significantly for the UL combining (e.g. receiver noise, unmodeled interference) and the DL precoding (e.g. parameter estimation uncertainty). In particular, in some examples, the interference situation can be substantially between the UL and DL.

In some examples of this disclosure, therefore, the first AP may, based on the channel information, calculate separate interference suppression weights for UL and DL for the APs in a group. In other examples, however, a single set of weights may be computed that are used for both the UL and the DL transmission directions. For example, this set of weights may be computed based on the MMSE beamforming principle. In computing this set of weights via the MMSE principle, a regularization term may be included that is selected to reduce the effects of interference and channel estimation errors both on the UL and the UL.

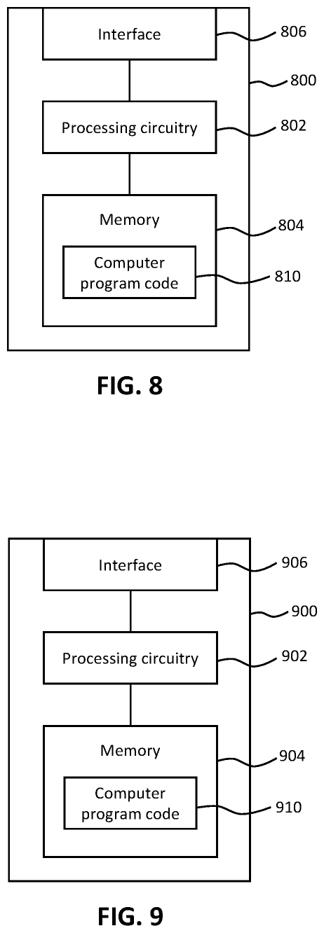

FIG. 8 is a schematic of an example of an apparatus 800 in a first access point (AP) of calculating interference suppression weights. The apparatus 800 comprises processing circuitry 802 (e.g., one or more processors) and a memory 804 in communication with the processing circuitry 802. The memory 804 contains instructions, such as computer program code 810, executable by the processing circuitry 802. The apparatus 800 also comprises an interface 806 in communication with the processing circuitry 802. Although the interface 806, processing circuitry 802 and memory 804 are shown connected in series, these may alternatively be interconnected in any other way, for example via a bus.

In one embodiment, the memory 804 contains instructions executable by the processing circuitry 802 such that the apparatus 800 is operable/configured to receive, for each of at least one other access point, channel information for channels between the other access point and at least one User Equipment (UE), calculate, for each of the at least one other access point, the interference suppression weights based on the channel information received for the at least one other access point, wherein the interference suppression weights are for signals transmitted between the at least one other access point and the at least one UE, and send, to each of the at least one other access point, the interference suppression weights for the other access point. In some examples, the apparatus 800 is operable/configured to carry out the method 400 described above with reference to FIG. 4.

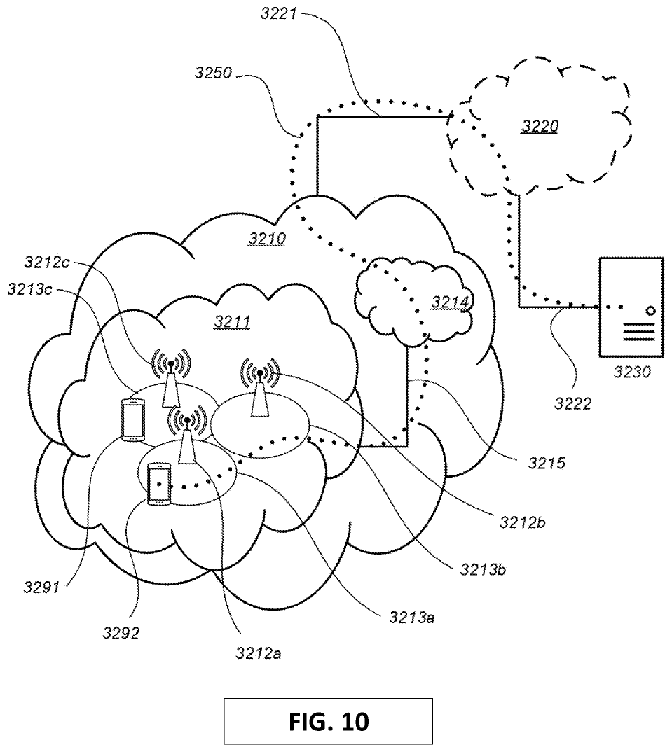

FIG. 9 is a schematic of an example of an apparatus 900 in a first access point (AP) of processing signals. The apparatus 900 comprises processing circuitry 902 (e.g., one or more processors) and a memory 904 in communication with the processing circuitry 902. The memory 904 contains instructions, such as computer program code 910, executable by the processing circuitry 902. The apparatus 900 also comprises an interface 906 in communication with the processing circuitry 902. Although the interface 906, processing circuitry 902 and memory 904 are shown connected in series, these may alternatively be interconnected in any other way, for example via a bus.

In one embodiment, the memory 904 contains instructions executable by the processing circuitry 902 such that the apparatus 900 is operable/configured to send channel estimates of channels between the second access point and the at least one UE to a first access point, receive, from the first access point, interference suppression weights, and process signals transmitted between the second access point and the at least one UE based on the interference suppression weights. In some examples, the apparatus 900 is operable/configured to carry out the method 700 described above with reference to FIG. 7.

Examples of the present disclosure also include apparatus in a first access point (AP) of calculating interference suppression weights. The apparatus comprises a receiving module configured to receive, for each of at least one other access point, channel information for channels between the other access point and at least one User Equipment (UE); a calculating module configured to calculate, for each of the at least one other access point, the interference suppression weights based on the channel information received for the at least one other access point, wherein the interference suppression weights are for signals transmitted between the at least one other access point and the at least one UE; and a sending module configured to send, to each of the at least one other access point, the interference suppression weights for the other access point.

Examples of the present disclosure also include apparatus in a first access point (AP) of processing signals. The apparatus comprises a sending module configured to send channel estimates of channels between the second access point and the at least one UE to a first access point; a receiving module configured to receive, from the first access point, interference suppression weights; and a processing module configured to process signals transmitted between the second access point and the at least one UE based on the interference suppression weights.

Examples of this disclosure may also provide a communication system including a host computer comprising processing circuitry configured to provide user data, and a communication interface configured to forward the user data to a network for transmission to a user equipment (UE), wherein the network comprises a base station (or access point) having a radio interface and processing circuitry, the base station's processing circuitry configured to perform any of the example methods as disclosed herein performed by an access point. The system may further include the base station. Additionally or alternatively, the system may further include the UE, wherein the UE is configured to communicate with the base station. The processing circuitry of the host computer may be configured to execute a host application, thereby providing the user data, and the UE may comprise processing circuitry configured to execute a client application associated with the host application.

Examples of this disclosure may also provide a method implemented in a communication system including a host computer, a base station (or access point) and a user equipment (UE). The method comprises, at the host computer, providing user data and, at the host computer, initiating a transmission carrying the user data to the UE via a network comprising the base station, wherein the base station may perform any of the example methods as disclosed herein performed by an access point. The method may also comprise, at the base station, transmitting the user data. The user data may be provided at the host computer by executing a host application, the method may further comprise, at the UE, executing a client application associated with the host application.

Examples of this disclosure may also provide a communication system including a host computer comprising processing circuitry configured to provide user data, and a communication interface configured to forward user data to a network for transmission to a user equipment (UE). The UE comprises a radio interface and processing circuitry, the UE's processing circuitry configured to perform any of the example methods as disclosed herein performed by a UE. The system may further include the UE. The network may further include a base station (or access point) configured to communicate with the UE. The processing circuitry of the host computer may be configured to execute a host application, thereby providing the user data, and the UE's processing circuitry may be configured to execute a client application associated with the host application.

Examples of this disclosure may also provide a method implemented in a communication system including a host computer, a base station (or access point) and a user equipment (UE), the method comprising, at the host computer, providing user data and, at the host computer, initiating a transmission carrying the user data to the UE via a network comprising the base station, wherein the UE may perform any of the example methods as disclosed herein performed by a UE. The method may further comprise, at the UE, receiving the user data from the base station.

Examples of this disclosure may also provide a communication system including a host computer comprising a communication interface configured to receive user data originating from a transmission from a user equipment (UE) to a base station (or access point), wherein the UE comprises a radio interface and processing circuitry, the UE's processing circuitry configured to perform any of the example methods as disclosed herein performed by a UE. The system may further include the UE. The system may further include the base station, wherein the base station comprises a radio interface configured to communicate with the UE and a communication interface configured to forward to the host computer the user data carried by a transmission from the UE to the base station. The processing circuitry of the host computer may be configured to execute a host application, and the UE's processing circuitry may be configured to execute a client application associated with the host application, thereby providing the user data. The processing circuitry of the host computer may be configured to execute a host application, thereby providing request data, and the UE's processing circuitry may be configured to execute a client application associated with the host application, thereby providing the user data in response to the request data.

Examples of this disclosure may also provide a method implemented in a communication system including a host computer, a base station (or access point) and a user equipment (UE). The method comprises, at the host computer, receiving user data transmitted to the base station from the UE, wherein the UE may perform any of the example methods as disclosed herein performed by a UE. The method may further comprise, at the UE, providing the user data to the base station. The method may further comprise, at the UE, executing a client application, thereby providing the user data to be transmitted and, at the host computer, executing a host application associated with the client application. The method may further comprise, at the UE, executing a client application and, at the UE, receiving input data to the client application, the input data being provided at the host computer by executing a host application associated with the client application, wherein the user data to be transmitted is provided by the client application in response to the input data.

Examples of this disclosure may also provide a communication system including a host computer comprising a communication interface configured to receive user data originating from a transmission from a user equipment (UE) to a base station (or access point), wherein the base station comprises a radio interface and processing circuitry, the base station's processing circuitry configured to perform any of the example methods as disclosed herein performed by a UE. The system may further include the base station. The system may further include the UE, wherein the UE is configured to communicate with the base station. The processing circuitry of the host computer may be configured to execute a host application, and the UE may be configured to execute a client application associated with the host application, thereby providing the user data to be received by the host computer.

Examples of this disclosure may also provide a method implemented in a communication system including a host computer, a base station (or access point) and a user equipment (UE). The method comprises, at the host computer, receiving, from the base station, user data originating from a transmission which the base station has received from the UE, wherein the UE may perform any of the example methods as disclosed herein performed by a UE. The method may further comprise, at the base station, receiving the user data from the UE. The method may further comprise, at the base station, initiating a transmission of the received user data to the host computer.

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

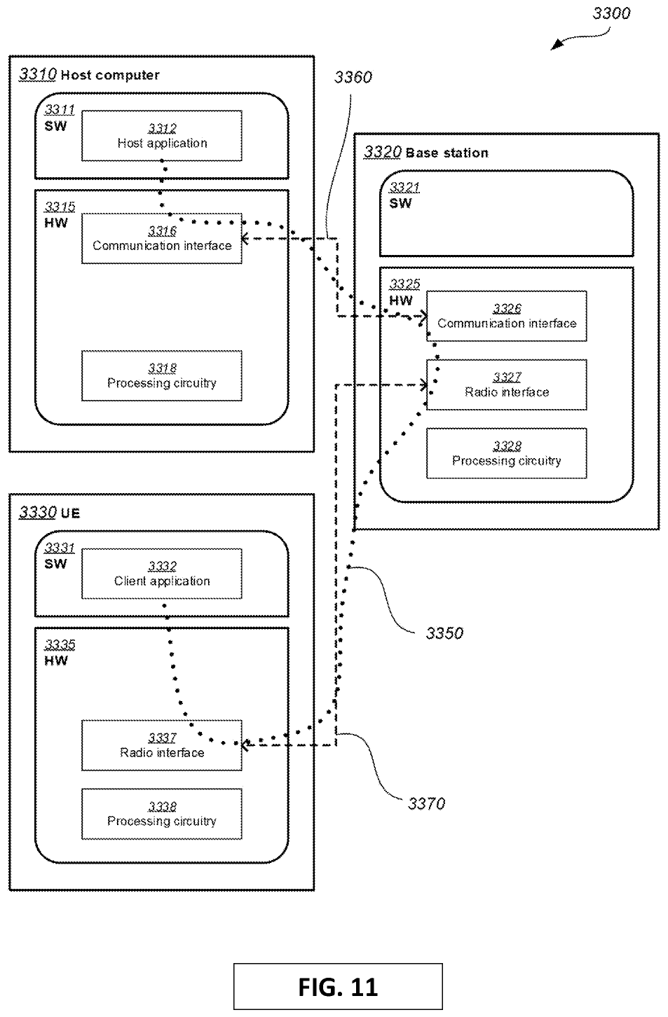

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

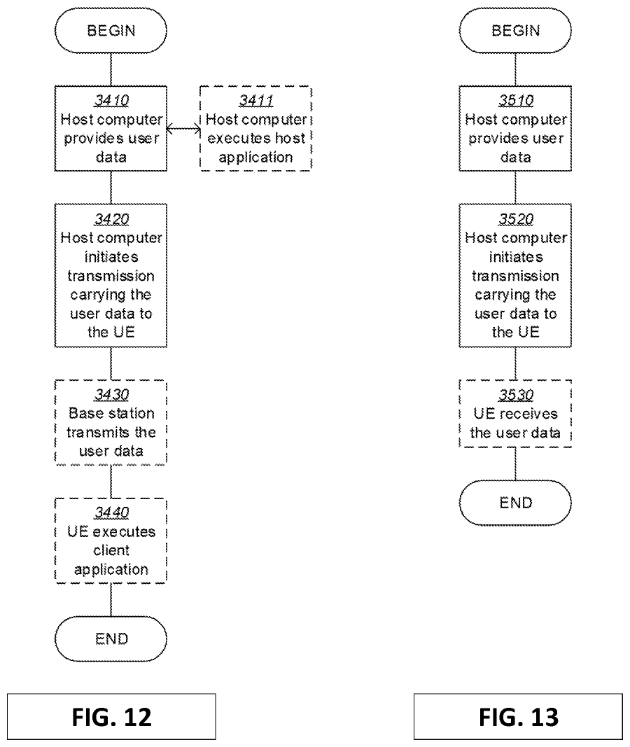

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

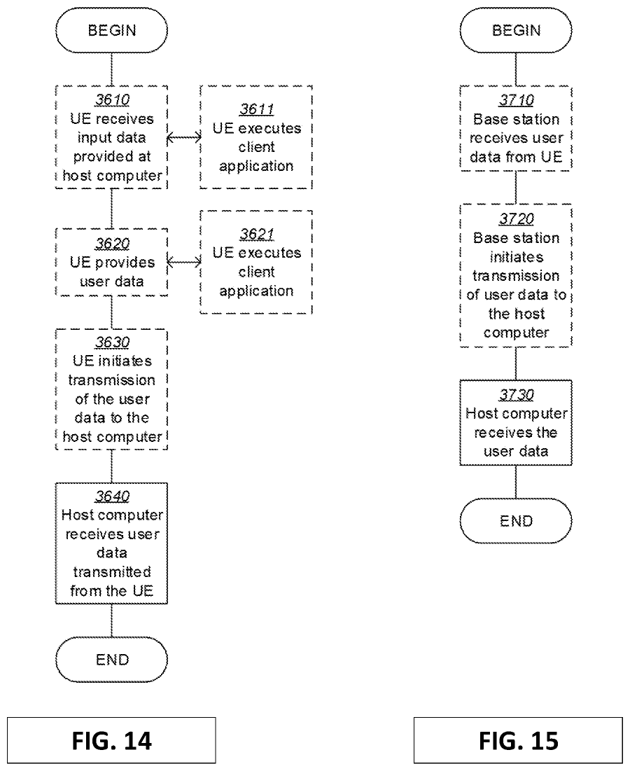

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first access point (AP) of calculating interference suppression weights, the method comprising:
receiving, for each of at least one other access point, channel information for channels between the other access point and at least one User Equipment (UE);
calculating, for each of the at least one other access point, the interference suppression weights based on the channel information received for the at least one other access point, the at least one other access point comprising a group of access points serving the at least one UE;
receiving, for each of at least one of the at least one other access point, channel information for channels between the other access point and at least one additional UE, the at least one additional UE is not served by the group of access points serving the at least one UE;
calculating, for each of the at least one of the at least one other access point, the interference suppression weights based on the channel information received for the at least one other access point comprising calculating the interference suppression weights based further on channel information for channels between the other access point and the additional UE; and
sending, to each of the at least one other access point, the interference suppression weights for the other access point.

2. The method of claim 1, wherein:
the channel information for channels between the other access point and the at least one UE for each of the at least one other access point comprises channel information between each antenna of the other access point and each of the at least one UE; and
the interference suppression weights for signals transmitted between each of the at least one other access point and the at least one UE comprise interference suppression weights for signals transmitted between each antenna of the other access point and each of the at least one UE.

3. The method of claim 1, comprising:
determining channel information for channels between the first access point and the at least one UE; and
wherein calculating the interference suppression weights based on the channel information received for the at least one other access point comprises calculating the interference suppression weights based further on the channel information for channels between the first access point and the at least one UE and includes calculating, for the first access point, interference suppression weights for signals transmitted between the first access point and the at least one UE.

4. The method of claim 3, comprising transmitting signals to the at least one UE based on the interference suppression weights for the first access point.

5. (canceled)

6. The method of claim 1, wherein the group of access points serving the at least one UE includes the first access point.

7. (canceled)

8. The method of claim 1, wherein the interference suppression weights cause at least one of the at least one other access point to not transmit to at least one of the at least one UE.

9. The method of claim 8, comprising selecting one or both of the at least one of the at least one other access point and at least one UE based on a respective maximum transmit power of the at least one of the at least one other access point.

10. The method of claim 1, comprising:
receiving, from at least one of the at least one access point, an indication of a scaling parameter for the interference suppression weights for the at least one of the at least one AP;
updating the interference suppression weights for each of the at least one other access point based on the scaling parameter; and
sending, to each of the at least one other access point, the updated interference suppression weights for the other access point.

11. The method of claim 1, wherein the interference suppression weights comprise, for at least one of the at least one access point:
first interference suppression weights for signals transmitted between the at least one of the at least one other access point and a first subset of the at least one UE; and
second interference suppression weights for signals transmitted between the at least one of the at least one other access point and a second subset of the at least one UE.

12. The method of claim 1, wherein:
receiving, for each of at least one other access point, the channel information for the channels between the other access point and the at least one UE comprises receiving the channel information over a respective fronthaul link between the other access point and the first access point; and
sending, to each of the at least one other access point, the interference suppression weights for the other access point comprises sending the interference suppression weights over the respective fronthaul link between the other access point and the first access point.

13. The method of claim 1, comprising:
receiving, for each of a first subset of the at least one other access point, the channel information for the channels between the other access point and the at least one UE over a respective fronthaul link between the other access point and the first access point;
receiving, for each of a second subset of the at least one other access point, the channel information for the channels between the other access point and the at least one UE from the other access point via the respective fronthaul link between the first access point and one of the first subset, wherein the first subset is different to the second subset;
sending, to each of the first subset of the at least one other access point, the interference suppression weights for the other access point over the respective fronthaul link between the other access point and the first access point; and
sending, to each of the second subset of the at least one other access point, the interference suppression weights for the other access point over the respective fronthaul link between the first access point and one of the first subset.

14. The method of claim 1, wherein the interference suppression weights comprise downlink (DL) signal precoding weights and/or uplink (UL) signal combining weights.

15. A method in a second access point of processing signals, the method comprising:
sending channel estimates of channels between the second access point and the at least one UE to a first access point;
receiving, from the first access point, interference suppression weights;
processing signals transmitted between the second access point and at least one UE based on the interference suppression weights; and
the second access point is in a group of access points serving the at least one UE, the interference suppression weights causing the second access point to suppress interference towards at least one additional UE, the at least one additional UE is not served by the group of access points serving the at least one UE.

16. The method of claim 15, comprising:
receiving, from each of at least one other access point, channel estimates of channels between the second access point and the at least one UE;
forwarding the channel estimates from the at least one other access point to the first access point;
receiving, from the first access point, respective other interference suppression weights for each of the at least one other access point; and
forwarding, to each of the at least one other access point, the respective other interference suppression weights.

17. The method of claim 15, comprising receiving information identifying the first access point from a processing node.

18. The method of claim 15, wherein the interference suppression weights comprise weights for each antenna of a plurality of antennas of the second access point and for each UE of the at least one UE.

19. (canceled)

20. (canceled)

21. The method of claim 15, wherein the interference suppression weights cause the second access point to not transmit to at least one of the at least one UE.

22. The method of claim 15, wherein the interference suppression weights comprise one or both downlink (DL) signal precoding weights and uplink (UL) signal combining weights.

23. The method of claim 15, wherein processing signals transmitted between the second access point and the at least one UE based on the interference suppression weights comprises one or both:
transmitting the signals to the at least one UE based on the interference suppression weights; and
processing the signals received from the at least one UE based on the interference suppression weights.

24. The method of claim 15, comprising:
sending, to the first access point, an indication of a scaling parameter for the interference suppression weights based on the interference suppression weights; and
receiving, from the first access point, updated interference suppression weights based on the scaling parameter; and
wherein processing the signals transmitted between the second access point and the at least one UE based on the interference suppression weights comprises processing the based on the updated interference suppression weights.

25.-57. (canceled)
